(19) United States
(12) Patent Application Publication
(10) Pub. No.: US 2025/0036996 A1
(43) Pub. Date: Jan. 30, 2025

(54) TECHNIQUE FOR PREPARING A FAULT-TOLERANT CLUSTER STATE

(71) Applicant: Yale University, New Haven, CT (US)

(72) Inventors: Shruti Puri, Cheshire, CT (US); Jahan Claes, Wilton, CT (US); Kaavya Sahay, New Haven, CT (US)

(73) Assignee: Yale University, New Haven, CT (US)

(21) Appl. No.: 18/716,891

(22) PCT Filed: Dec. 6, 2022
(86) PCT No.: PCT/US2022/051990

§ 371 Date: Jun. 5, 2024

Related U.S. Application Data
(60) Provisional application No. 63/292,868, filed on Dec. 22, 2021.
(60) Provisional application No. 63/286,362, filed on Dec. 6, 2021.

(51) Int. Cl. G06N 10/40

(52) U.S. Cl. CPC G06N 10/40

(57) ABSTRACT

Quantum systems and techniques are described to generate fault tolerant cluster states for use in quantum computation, quantum networking, and other applications. The systems and techniques include initializing states in first qubits and generating initial resource states by performing first Pauli product measurements on sets of X-type and/or Z-type qubits of the first qubits, the initial resource states comprising qubit cluster states comprising at least three qubits. The final cluster state may then be generated by fusing two or more initial resource states, the fusing comprising performing second Pauli product measurements between qubits of two or more of the initial resource states.

### CROSS REFERENCE TO RELATED APPLICATIONS

This application claims the benefit under 35 U.S.C. § 119(e) of U.S. Provisional Patent Application No. 63/286,362, filed Dec. 6, 2021, titled “TECHNIQUE FOR PREPARING A FAULT-TOLERANT CLUSTER STATE” and of U.S. Provisional Patent Application No. 63/292,868, filed Dec. 22, 2021, titled “TECHNIQUE FOR PREPARING A FAULT-TOLERANT CLUSTER STATE,” each of which is incorporated herein by reference in its entirety.

### STATEMENT REGARDING FEDERALLY-SPONSORED RESEARCH

This invention was made with government support under OMA-2137740 awarded by the National Science Foundation. The government has certain rights in the invention.

### BACKGROUND

Quantum information processing techniques perform computations by manipulating one or more quantum objects. These techniques are sometimes referred to as “quantum computing.” In order to perform computations, a quantum information processor utilizes quantum objects to reliably store and retrieve information. According to some quantum information processing approaches, a quantum analogue to the classical computing “bit” (being equal to 1 or 0) has been developed, which is referred to as a quantum bit, or “qubit.” A qubit can be composed of any quantum system that has two distinct states (which may be thought of as 1 and 0 states), but also has the special property that the system can be placed into quantum superpositions and thereby exist in both of those states at once.

### BRIEF SUMMARY

Some embodiments are directed to a quantum system. The quantum system comprises at least one controller and at least one non-transitory computer readable medium storing computer readable instructions configured to cause the at least one controller to generate an XZZX cluster state. Generating the XZZX cluster state comprises: initializing states in first qubits, the first qubits comprising X-type and Z-type qubits; generating initial resource states by performing first Pauli product measurements on sets of X-type and/or Z-type qubits of the first qubits, the initial resource states comprising qubit cluster states comprising at least three qubits; and generating the XZZX cluster state by fusing two or more initial resource states, the fusing comprising performing second Pauli product measurements between qubits of two or more of the initial resource states.

Some embodiments are directed to a method of generating an XZZX cluster state. Generating the XZZX cluster state comprises: initializing states in first qubits, the first qubits comprising X-type and Z-type qubits; generating initial resource states by performing first Pauli product measurements on sets of X and/or Z qubits of the first qubits, the initial resource states comprising qubit cluster states comprising at least three qubits; and generating the XZZX cluster state by fusing two or more initial resource states, the fusing comprising performing second Pauli product measurements between qubits of two or more of the initial resource states.

In some embodiments, generating the initial resource states comprises generating a first three-qubit cluster state by: initializing states in two X-type qubits and one Z-type qubit; and generating the first three-qubit cluster state by performing a three-qubit Z measurement on the initialized qubits.

In some embodiments, generating the initial resource states comprises generating a five-qubit cluster state by fusing each of the two X-type qubits of the first three-qubit cluster state with a Z-type qubit of second and third three-qubit cluster states.

In some embodiments, fusing each of the two X-type qubits of the first three-qubit cluster state with a Z-type qubit of second and third three-qubit cluster states comprises: performing two-qubit Z measurements between each of the two X-type qubits and the Z-type qubits; and performing two-qubit X measurements between each of the two X-type qubits and the Z-type qubits.

In some embodiments, generating the initial resource states comprises generating a four-qubit cluster state by: initializing states in three Z-type qubits and one X-type qubit; and generating the four-qubit cluster state by performing two-qubit Z measurements between each of the three Z-type qubits and the one X-type qubit.

In some embodiments, generating the initial resource states comprises generating a five-qubit cluster state by: initializing a state in an additional X-type qubit; and performing a CZ gate between the additional X-type qubit and the one X-type qubit of the four-qubit cluster state.

In some embodiments, generating the initial resource states comprises generating a four-qubit cluster state by: initializing states in four X-type qubits; and generating the four-qubit cluster state by performing two-qubit X measurements between pairs of qubits of the initialized four X-type qubits. In some embodiments, generating the four-qubit cluster state further comprises performing a Z measurement of three of the initialized four X-type qubits.

In some embodiments, generating the initial resource states comprises generating a six-qubit cluster state by: generating three three-qubit cluster states; and fusing qubits of the three three-qubit cluster states to generate a six-qubit cluster state comprising two Z-type qubits and four X-type qubits.

In some embodiments, generating the three three-qubit cluster states comprises: initializing states in six X-type qubits and three Z-type qubits; and for each of the three three-qubit cluster states, performing at least four two-qubit X and/or Z measurements to generate the three three-qubit cluster states.

In some embodiments, fusing two or more initial resource states comprises performing a Bell measurement between a first qubit of a first initial resource state and a second qubit of a second initial resource state.

In some embodiments, initializing the states in the first qubits comprises generating photonic qubits using single photon sources.

In some embodiments, initializing the states in the first qubits comprises: generating one or more optical or microwave signals using one or more optical or microwave sources; and transmitting the generated one or more optical or microwave signals to the first qubits to initialize the states.

Some embodiments are directed to a quantum system. The quantum system comprises: a plurality of physical qubits; at least one computer readable medium storing a plurality of drive waveforms; and at least one controller configured to: initialize an alternating grid of X-start and Z-start cluster states in physical qubits of the plurality of physical qubits; initialize at least one physical qubit of the plurality of physical qubits to be an X-type qubit; and measure at least one physical qubit of the plurality of physical qubits in an X-basis to measure XZZX stabilizers of corresponding cluster states.

Some embodiments are directed to a method of building a fault-tolerant cluster state using a quantum system that includes a plurality of physical qubits. The method comprises: initializing an alternating grid of X-start and Z-start cluster states in physical qubits of the plurality of physical qubits; initializing at least one physical qubit of the plurality of physical qubits to be an X-type qubit; and measuring at least one physical qubit of the plurality of physical qubits in an X-basis to measure XZZX stabilizers of corresponding cluster states.

In some embodiments, initializing an alternating grid of X-start and Z-start cluster states comprises applying one or more CX and/or CZ gates to one or more of the plurality of physical qubits.

In some embodiments, the method further comprises teleporting logical information to other physical qubits of the plurality of physical qubits by: measuring X-type physical qubits in the X basis; and measuring Z-type physical qubits in a Z basis.

In some embodiments, the method further comprises detecting an error in one of the plurality of physical qubits by measuring one of a Z error on an X-type physical qubit or an X error on a Z-type physical qubit.

In some embodiments, detecting an error comprises: detecting a flipped stabilizer by measuring at least one X-type qubit.

### BRIEF DESCRIPTION OF THE DRAWINGS

Various aspects and embodiments are described with reference to the following drawings. The drawings are not necessarily drawn to scale. For the purposes of clarity, not every component may be labeled in every drawing. In the drawings:

FIG. 1A is a schematic diagram depicting the Raussendorf-Harrington-Goyal (RHG) surface code, in accordance with some embodiments described herein.

FIG. 1B is a schematic diagram depicting the XZZX surface code, in accordance with some embodiments described herein.

FIG. 2 is a schematic diagram of an illustrative quantum system suitable for initializing the RHG and/or XZZX surface codes, in accordance with some embodiments described herein.

FIG. 3 is a schematic diagram of another illustrative quantum system suitable for initializing the RHG and/or XZZX surface codes, in accordance with some embodiments described herein.

FIGS. 4A and 4B are schematic diagrams illustrating diagrammatic notation of coupling between two qubits initialized in the |+ [symbol] state and coupling between a qubit initialized in the |+ [symbol] state and a qubit initialized in an arbitrary state, |ψ [symbol] , where the coupling is generated by a CZ gate, in accordance with some embodiments described herein.

FIG. 4C is a schematic diagram illustrating teleportation of the one-dimensional cluster state using logical operators and stabilizer measurements, in accordance with some embodiments described herein.

FIG. 4D is a schematic diagram illustrating teleportation of the one-dimensional cluster state using only logical operators, in accordance with some embodiments described herein.

FIG. 4E is a schematic diagram illustrating the formation of the RHG cluster state by coupling ancilla qubits to the one-dimensional cluster state such that multi-qubit logical operators are measured during teleportation, in accordance with some embodiments described herein.

FIG. 4F is a schematic diagram depicting the RHG cluster state, in accordance with some embodiments described herein.

FIG. 4G is a schematic diagram of X and Z errors in an RHG cluster state, in accordance with some embodiments described herein.

FIGS. 5A, 5B, and 5C are schematic diagrams illustrating diagrammatic notation of coupling between (i) a Z-type qubit initialized in the |0 [symbol] state and an X-type qubit initialized in the |+ [symbol] state, (ii) a Z-type qubit initialized in the |0 [symbol] state and an X-type qubit initialized in an arbitrary state, |ψ [symbol] , and (iii) a Z-type qubit initialized in an arbitrary state, |ψ [symbol] , and an X-type qubit initialized in the |+ [symbol] state, where the coupling is generated by a CX gate, in accordance with some embodiments described herein.

FIG. 5D is a schematic diagram illustrating teleportation of the one-dimensional cluster state started with an X-type qubit using logical operators and stabilizer measurements, in accordance with some embodiments described herein.

FIG. 5E is a schematic diagram illustrating teleportation of the one-dimensional cluster state started with an X-type qubit using only logical operators, in accordance with some embodiments described herein.

FIG. 5F is a schematic diagram illustrating teleportation of the one-dimensional cluster state started with a Z-type qubit using logical operators and stabilizer measurements, in accordance with some embodiments described herein.

FIG. 5G is a schematic diagram illustrating teleportation of the one-dimensional cluster state started with a Z-type qubit using only logical operators, in accordance with some embodiments described herein.

FIG. 5H is a schematic diagram illustrating the formation of the XZZX cluster state by coupling ancilla qubits to the one-dimensional cluster state such that multi-qubit logical operators are measured during teleportation, in accordance with some embodiments described herein.

FIG. 5I is a schematic diagram of a unit cell of the XZZX surface code, in accordance with some embodiments described herein.

FIG. 5J is a schematic diagram of effects of X and Z errors in an XZZX surface code, in accordance with some embodiments described herein.

FIG. 6 is a graph showing the threshold error rate as a function of bias for XZZX and RHG cluster states, in accordance with some embodiments described herein.

FIGS. 7A and 7B are schematic diagrams of illustrative fusion measurements on pairs of X- and Z-type qubits, in accordance with some embodiments described herein.

FIGS. 7C and 7D are schematic diagrams of illustrative three- and four-qubit cluster states, in accordance with some embodiments described herein.

FIG. 7E is a schematic diagram illustrating the generation of a larger five-qubit cluster state by fusing three-qubit cluster states, in accordance with some embodiments described herein.

FIG. 7F is a schematic diagram illustrating the generation of another five-qubit cluster state, in accordance with some embodiments described herein.

FIG. 7G is a schematic diagram illustrating the generation of a portion of the XZZX cluster state using five-qubit cluster states, in accordance with some embodiments described herein.

FIG. 7H is a schematic diagram illustrating the arrangement of five-qubit cluster states, in accordance with some embodiments described herein.

FIGS. 8A and 8B are schematic diagrams illustrating alternative four-qubit cluster states that may be used to generate the XZZX cluster state, in accordance with some embodiments described herein.

FIG. 8C is a schematic diagram of an illustrative photonic circuit to generate the four-qubit cluster states of FIGS. 8A and 8B, in accordance with some embodiments described herein.

FIG. 9A is a schematic diagram illustrating a six-qubit cluster state, in accordance with some embodiments described herein.

FIGS. 9B and 9C are schematic diagrams illustrating three-qubit cluster states that may be used to generate the six-qubit cluster state of FIG. 9A, in accordance with some embodiments described herein.

FIG. 9D is a schematic diagram illustrating the fusion process used to generate the six-qubit cluster state of FIG. 9A, in accordance with some embodiments described herein.

FIG. 9E is a schematic diagram of an illustrative photonic circuit to generate the three-qubit cluster states of FIGS. 9B and 9C, in accordance with some embodiments described herein.

FIG. 9F is a schematic diagram of an illustrative photonic circuit to generate the six-qubit cluster state of FIG. 9A, in accordance with some embodiments described herein.

FIGS. 9G and 9H are schematic diagrams illustrating fusion operations on pairs of Z-type and X-type qubits, in accordance with some embodiments described herein.

FIG. 91 is a schematic diagram illustrating a fusion pattern used to join six-qubit cluster states to form the XZZX cluster state, in accordance with some embodiments described herein.

FIG. 10 is a plot of the probability of loss per photon as a function of the probability of failure of a fusion operation for the generation of the XZZX cluster state using four-qubit and six-qubit cluster states, in accordance with some embodiments described herein.

FIG. 11 is a flowchart describing a process of generating the XZZX cluster state using fusion measurements, in accordance with some embodiments described herein.

FIG. 12 is a schematic diagram of an illustrative conventional computer system, in accordance with some embodiments described herein.

### DETAILED DESCRIPTION

There are two main approaches to building a quantum computer. In circuit-model quantum computing, gates are applied to qubits that remain fixed throughout the computation. In contrast, measurement-based quantum computing (MBQC) proceeds by preparing qubits in an entangled resource state comprising a many-body entangled state, known as a “cluster state.” The cluster state may then be used to perform computations by measuring the qubits in certain bases. MBQC is particularly suited for photonic quantum computing platforms, as photons are measured soon after they are prepared, but is also applicable to cavity quantum electrodynamics (cQED) systems, trapped neutral atom quantum computing systems, and trapped ion quantum computing systems. MBQC is also suitable when the physically available gate and other operations are limited in the physical hardware, for example, when only destructive single or multi-qubit measurements are available at the physical level. Apart from MBQC, cluster states are also useful for robust quantum communication and networking.

A primary challenge in building a quantum technology is correcting errors in the physical quantum hardware. Quantum error-correcting codes allow one to detect and correct errors in hardware by storing information redundantly, provided the probability of error is below some threshold value. Error-correcting codes with high error thresholds are desirable because they can tolerate a noisier hardware.

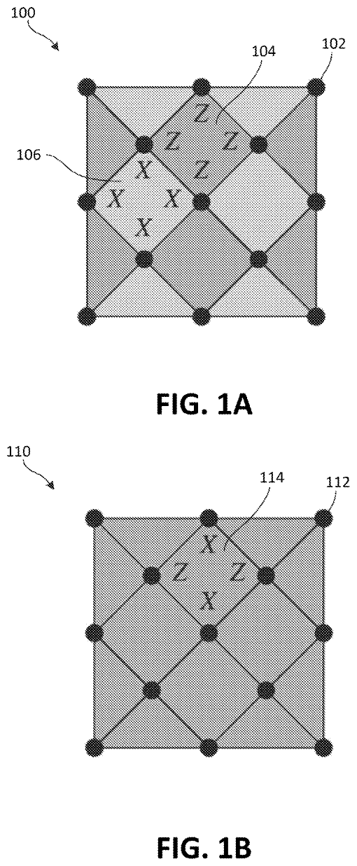

The inventors have recognized and appreciated that error correcting codes can be embedded in cluster states. Quantum error-correcting codes in the circuit model may be converted to error-correcting cluster states for MBQC using a method known as foliation. A standard cluster state used widely is called the Raussendorf-Harrington-Goyal (RHG) lattice. This cluster state is created by foliating the standard surface code depicted in FIG. 1A. The two-dimensional surface code 100 is characterized by a network of qubits 102 arranged in alternating plaquettes 104 and 106 with X and Z stabilizers. The RHG lattice is built by preparing the standard surface code 100 with qubits in |+ [symbol] states, and then entangling pairs of qubits using controlled-phase (CZ) gates.

The inventors have further recognized that some qubit hardware exhibits asymmetric or biased noise (e.g., when one type of error, like phase-flips, is more dominant than others, like bit-flips), and this feature can be exploited for more efficient error correction. The inventors have recognized and appreciated that the process of foliation converts high-probability errors into low-probability errors, effectively symmetrizing the noise channel. In other words, this process is not bias-preserving. New types of surface codes, like the XZZX code, have recently been discovered for effective error correction of biased noise in the circuit-based approach. The XZZX surface code 110 is schematically depicted in FIG. 1B and comprises a network of qubits 112 having the same X and Z stabilizers on each plaquette 114.

The inventors have recognized that standard foliation of codes such as the XZZX surface code will not result in a high-threshold cluster state even if the underlying qubits have biased noise because of the noise-symmetrization effect described above. The inventors have accordingly developed error-correcting codes for MBQC systems that is bias-preserving. The error-correcting code includes a generalized cluster state as a tool for fault-tolerance in the measurement-based model. When noise is dominated by phase-flips, the generalized cluster state is built by preparing qubits in the |0 [symbol] and |+ [symbol] states, and then entangling pairs of qubits using both controlled-phase (CZ) and controlled-not (CX) gates. Using the generalized cluster state, a foliation protocol that preserves the noise bias can be constructed. This property allows the use of the generalized cluster state to build high-threshold foliated versions of stabilizer codes designed for biased noise in the circuit-based approach. While this method could be applied to any stabilizer code, the description herein explicitly focuses on foliating the XZZX surface code as it can be decoded (i.e., the location of errors can be determined) efficiently with a simple matching decoder. Under biased circuit-level noise, this new cluster state, the XZZX cluster state, is shown to have approximately twice a higher noise threshold than the standard RHG cluster state (i.e., 2.2% versus under 1.0%).

According to some embodiments, the generalized cluster state is first built using an entangled linear chain of qubits (a “linear cluster state”) which is a stabilizer state of two sets of stabilizer operators: one set which involves a product of one type of Pauli operators (e.g., a product of Pauli-Zs) and the other set which involves a product of another type of Pauli operators (e.g., a product of Pauli-Xs). Such linear cluster states may then be foliated with other stabilizer codes using standard techniques.

The foliation procedure described herein extends existing foliation procedures using the generalized cluster state to create error-correcting states that can take advantage of biased noise. The existing foliation procedure does not respect noise bias, in that it converts Z-errors to a mix of effective Z-errors and effective X-errors. This does not allow one to take advantage of circuit-model codes with high thresholds against biased noise. Using the generalized cluster state, a foliation procedure has been developed that preserves biased noise, resulting in error-correcting cluster states with high thresholds against biased noise.

Several experimental platforms have the capability of realizing the basic operations to create the generalized cluster state. To realize an advantage with the XZZX cluster state, a high-quality qubit that naturally lends itself to MBQC and whose errors are biased is desirable. As an example, the generalized cluster state can be realized in a dual-rail photonic platform. Furthermore, the generalized cluster state can also be realized in circuit-QED, trapped neutral atom systems, as well as optomechanics architectures.

The present application relates to an improved quantum error correction technique for correcting errors in the state of a quantum system. An “error” in this context refers to a change in the state of the quantum system that may be caused by, for instance, qubit losses, qubit gains, dephasing, time evolution of the system, etc., and which alters the state of the system such that the information stored in the system is altered.

### I. Illustrative Hardware Implementations

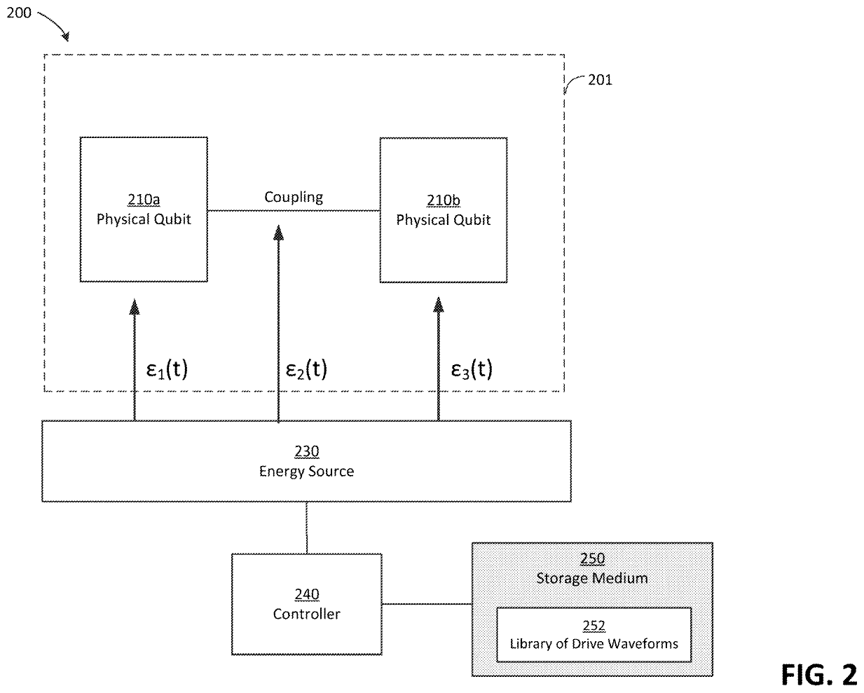

FIG. 2 depicts an illustrative quantum system suitable for practicing aspects of the present application. In system 200, physical qubit 210a is coupled to another physical qubit 210b. Energy source 230 may supply energy to one or both of physical qubit 210a, physical qubit 210b, and/or to the coupling mechanism in order to perform operations on the system such as performing a gate operation on one or more of physical qubits 210a and/or 210b, applying other operations to one or more of physical qubits 210a and/or 210b (e.g., to correct a detected error, to build a cluster state using physical qubit 210a and/or 210b), or combinations thereof. It should be appreciated that while FIG. 2 shows only two physical qubits 210a and 210b, in some embodiments there may be multiple physical qubits 210a/210b, as aspects of the technology described herein are not limited in this regard.

According to some embodiments, physical qubit 210a and/or 210b may include any bosonic system supporting a plurality of bosonic modes, which may be implemented using any electromagnetic, mechanical, magnetic (e.g., quantized spin waves also known as magnons), and/or other techniques, such as but not limited to any cavity resonator (e.g., a microwave cavity), a photonic qubit, a trapped neutral atom qubit, and/or an optomechanical qubit.

System 200 also includes a system 201 in addition to energy source 230, controller 240 and storage medium 250. In some embodiments, a library of precomputed drive waveforms may be stored on a computer readable storage medium and accessed in order to apply said waveforms to a quantum system. For example, controller 240 may access drive waveforms 252 stored on storage medium 250 (e.g., in response to user input provided to the controller) and controls the energy source 230 to apply drive waveforms to the physical qubits 210a and/or 210b.

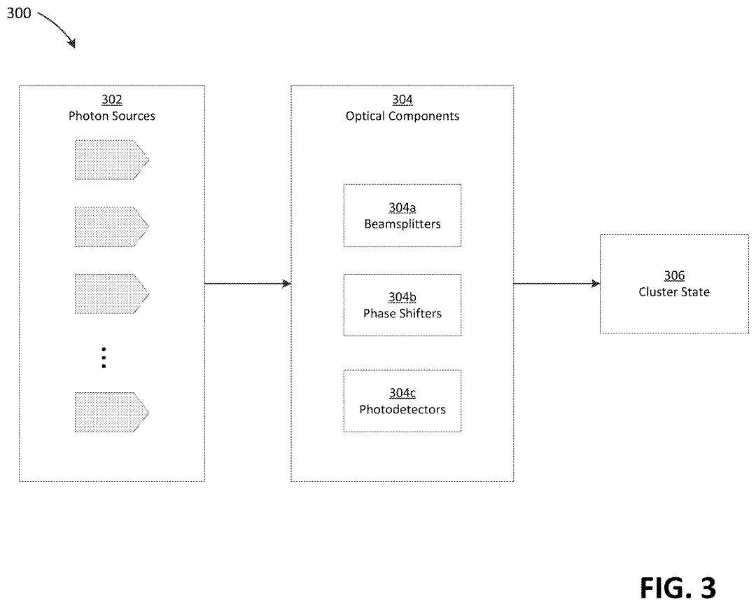

FIG. 3 shows another illustrative quantum system suitable for practicing aspects of the present application. System 300 includes photon sources 302 configured to generate single photons and/or photon pairs suitable for use as qubits.

In some embodiments, outputs of the photon sources 302 are coupled to an array of optical components 304. The array of optical components 304 may include any suitable optical components configured and arranged to perform one or more quantum operations on photonic qubits generated by photon sources 302. For example, the array of optical components 304 may include beamsplitters 304a, phase shifters 304b, and/or photodetectors 304c.

In some embodiments, the array of optical components 304 may be configured to perform a series of operations on the photonic qubits generated by photon sources 302 to assemble a cluster state 306. The cluster state 306 may be assembled in any suitable manner, as described herein. Accordingly, after passing through the array of optical components 304, the photonic qubits may be output from the array 304 as a cluster state 306.

### II. Building the RHG Cluster State Using Teleportation

Foliation is a flexible approach to build fault-tolerant cluster states from stabilizer codes. As one example of foliation, each qubit in a stabilizer code may be replaced with a one-dimensional cluster state that can be used to teleport a single logical degree of freedom. These one-dimensional cluster states may be coupled so that the stabilizers of the code are repeatedly measured during teleportation. These cluster states can then be used to fault-tolerantly store an initial encoded state. While the constructed cluster states do not apply logical gates during the teleportation, there are methods to modify the basic fault-tolerant cluster state to enable universal fault-tolerant MBQC.

To illustrate the idea of foliation, a review of how to build the RHG cluster state by foliating the surface code is described herein. The process begins by constructing a one-dimensional cluster state that can teleport a single qubit. Each surface code qubit is then replaced with a one-dimensional teleportation cluster state. During teleportation, the one-dimensional cluster states are coupled so that the surface code stabilizers may be measured. The resulting RHG cluster state may then be used to detect text use z, 22 errors.

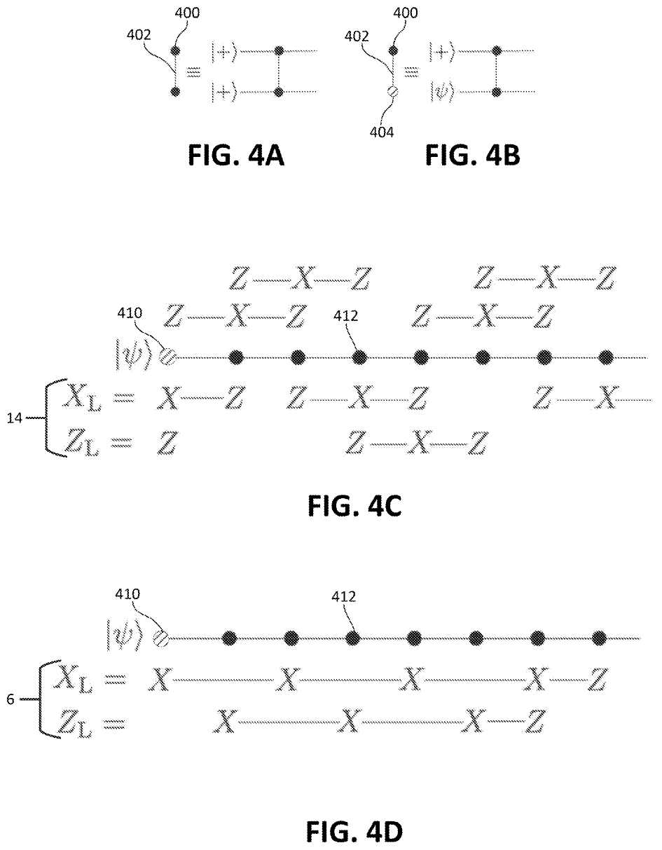

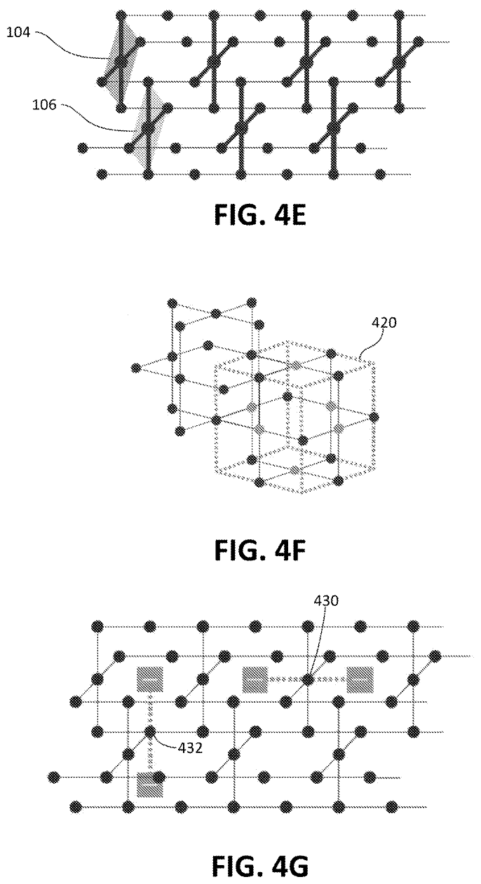

FIGS. 4A and 4B are schematic diagrams illustrating diagrammatic notation of coupling between two qubits initialized in the |+ [symbol] state and coupling between a qubit initialized in the |+ [symbol] state and a qubit initialized in an arbitrary state, |ψ [symbol] , where the coupling is generated by a CZ gate, in accordance with some embodiments described herein. Filled black circles 400 denote qubits initialized in the |+ [symbol] state while circles 404 with diagonal line fill denote qubits initialized in an arbitrary state. Qubits connected by a line 402 have a CZ gate applied between them.

The standard one-dimensional teleportation cluster state is illustrated in FIGS. 4C and 4D. To prepare the cluster state, with an arbitrary state |ψ [symbol] is initialized on the first qubit 410 and a |+ [symbol] state is initialized on the remaining qubits 412. Neighboring qubits are then entangled by applying controlled-phase or CZ gates to all pairs of neighbors. Importantly, the CZ gates are mutually commuting and may be applied in any order.

The stabilizer formalism can be used to describe the cluster state. Before the CZ gates, the logical Pauli operators on |ψ [symbol] are given by X_{L}=X₁ and Z_{L}Z₁, and the state is stabilized by {X₂, X₃, . . . }. After applying the CZ gates, the new logical operators and stabilizers are obtained from the old by conjugating with the CZ gates. This sends

$${Z}_{i} \to {Z}_{i}$$

$${X}_{i} \to {X}_{i} {\prod }_{j ∈ {𝒩}_{𝒾}} {Z}_{j}$$

where [symbol] ᵢ denotes the neighbors of site i. Thus, the cluster state has X_{L} X₁Z₂ and Z_{L}=Z₁, with stabilizers {Z₁X₂Z₃,Z₂X₃Z₄, . . . }. By multiplying the logical operators 414 by stabilizers, they can be rewritten in a form 416 involving only X operators on the first 2n qubits:

$${X}_{L} = ( {{\prod }_{i \leq 2 n}}_{i odd} {X}_{i} ) {X}_{2 n + 1} {Z}_{2 n + 2}$$

$${Z}_{L} = ( {{\prod }_{i \leq 2 n}}_{i even} {Z}_{i} ) {Z}_{2 n + 1}$$

The case of n=3 is illustrated in FIG. 4C. This form makes it clear that if the first 2n qubits are measured in the X basis, the logical operators will be teleported to qubits {2n+1, 2n+2}. For example, in the case n=3, if qubits 1-6 are measured with outcomes {x₁,x₂,x₃,x₄,x₅,x₆}, with xᵢ=±1, it is implied that the logical operators are given by:

X_{L}=x₁x₃x₅X₇Z₈

Z_{L}=x₂x₄x₆Z₇

To construct a fault-tolerant cluster state, individual one-dimensional teleportation cluster states may be combined, and the cluster may be modified to measure the check operators of a stabilizer code as the cluster is teleported. To generate the surface code, each qubit of the surface code shown in FIGS. 4A and 4B with a one-dimensional teleportation chain. For each X-stabilizer plaquette 106 of the surface code, an ancilla qubit may be attached to each set of odd sites of the teleportation chain, and for each Z-stabilizer plaquette 104 we attach an ancilla to each set of even sites of the teleportation chain, as shown in FIG. 4E. These ancilla qubits are also initialized in |+ [symbol] and entangled with their neighbors with CZ gates. Measuring an ancilla qubit in the X basis results in measuring the surface code stabilizer of the corresponding plaquette during the teleportation.

The resulting three-dimensional cluster state, the RHG cluster state is illustrated in FIG. 4F with a unit cell 420 highlighted with dashed lines. To fault-tolerantly teleport information through this state, both the data qubits and ancilla qubits are measured in the X basis. One can check that for an RHG cluster state without errors, the product of the X operators on the faces of a cell is a stabilizer of the cluster state, so the product of the X measurements around the faces of a cell should be (+1).

As an example, consider applying a single Pauli error to the RHG cluster state. A Z or Y error 430 on a face qubit flips the syndromes of the two neighboring cells, allowing for the detection of these errors, as shown in FIG. 4G. Multi-qubit Pauli errors can be detected similarly, by considering the syndromes they flip. Note that X errors 432 on the final cluster state have no effect, although X errors occurring between two CZ gates will propagate to Z errors on neighboring qubits. Errors can be corrected by pairing (−1) syndromes to each other using a minimum weight perfect matching (MWPM) decoder, and under this decoder the RHG cluster has a threshold for local Pauli noise.

This method of creating fault-tolerant cluster states can also be used to generate cluster states that realize the tailored or XZZX surface codes. However, these codes only offer improved thresholds over the usual surface code when the effective probability of bit-flip errors is suppressed compared to phase-flip errors. Unfortunately, the one-dimensional teleportation procedure outlined above unbiases the noise, converting physical Z errors into logical X errors. We can understand this phenomenon in two ways. Firstly, the Z_{L} operator includes physical X operators on qubits 2, 4, . . . , 2n so that Z errors on these qubits anticommute with Z_{L} and are therefore equivalent to an X_{L} error. Alternatively, if the logical information from qubits 1 and 2 is teleported to, e.g., qubits 7 and 8, accurate measurements x₁, . . . , x₆ are needed to recover the logical information about the state. A Z error on qubits 2, 4, or 6 would cause the measurement of the wrong sign of x₂, x₄, or x₆. This results in the replacement of Z_{L} with −Z_{L}, which is equivalent to an X_{L} error.

Physical Z noise therefore converts to logical X noise. Consequently, the effective error channel of the one-dimensional teleportation chains, which are subsequently combined to measure the check operators of an error correcting code, is not biased. Thus, the resulting fault-tolerant cluster state will not have an improved threshold even if the measured stabilizers correspond to a code that is specifically designed for biased noise, such as the XZZX surface code. In fact, the XZZX cluster state produced by this approach does not perform better than the standard RHG at any bias.

Naively, one might assume that while the RHG lattice is not robust to Z-biased noise, it should be robust to X-biased noise, since X errors on the RHG cluster state have no effect on the teleportation. However, even if physical qubits only experience X errors, applying CZ_{c,t}, where c denotes the control and t the target, propagates an X_{c} error to X_{c}Zₜ. Thus, if X errors occur during the construction of the RHG lattice, they propagate to Z errors on the final cluster, and it cannot be assumed that there is X-biased noise after the construction of the cluster state. By contrast, CZ gates commute with Z errors, so Z-biased noise is compatible with constructing the cluster state.

### III. Building the XZZX Cluster State Using Teleportation

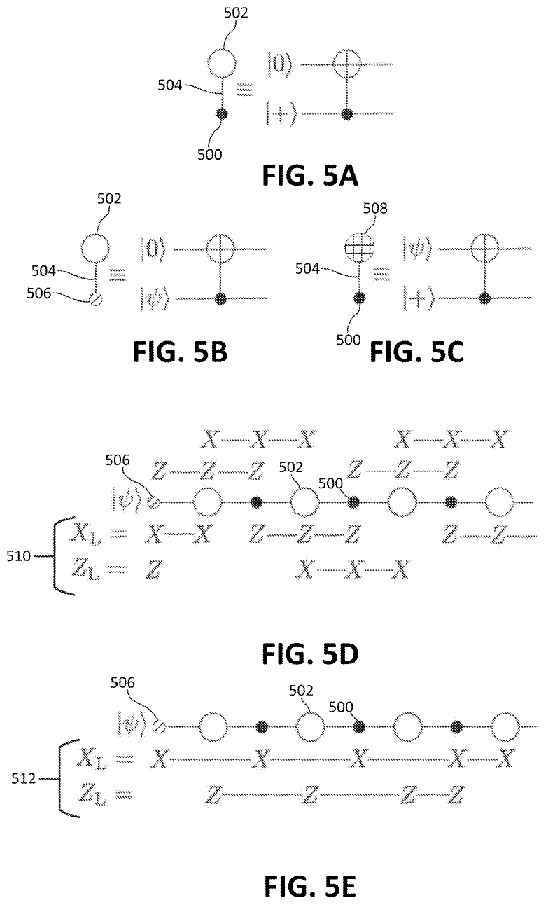

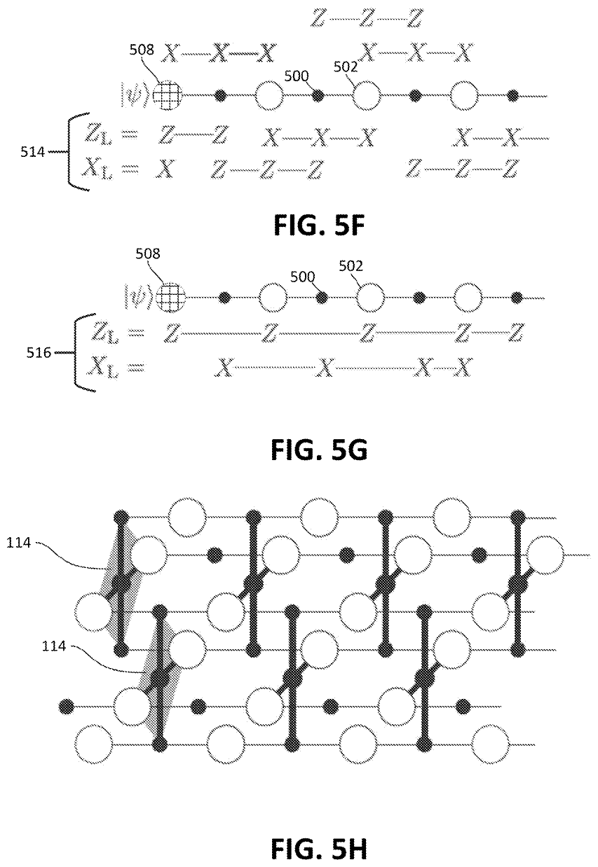

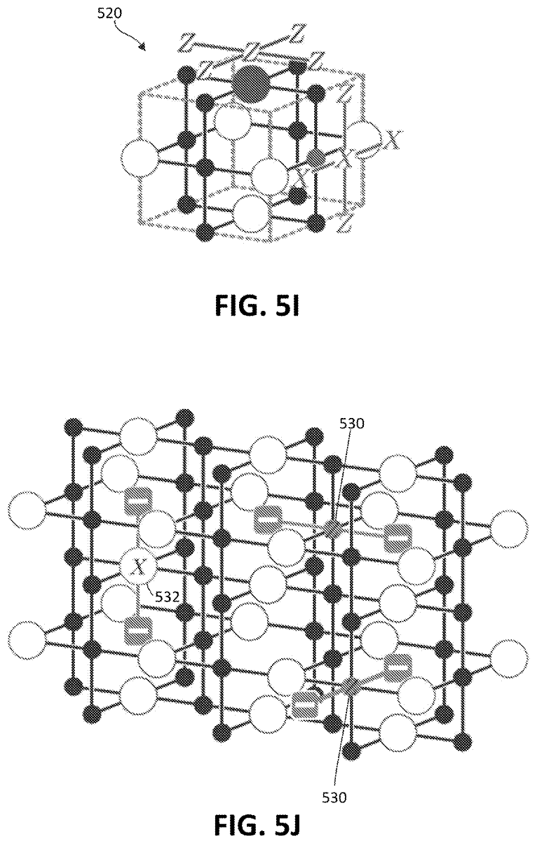

To build a cluster state that realizes the XZZX code, the usual construction of the cluster state can be modified with the goal of creating a one-dimensional teleportation cluster state in which Z_{L} contains only physical Z operators. To achieve this, the generalized cluster state is constructed with two types of qubits, X-type and Z-type. X-type qubits are initialized in the |+ [symbol] state and measured in the X basis, as in the usual cluster state, while Z-type qubits are initialized in the |0 [symbol] state and measured in the Z basis. As shown in FIGS. 5A-5C, X-type qubits are denoted by small, filled circles (e.g., qubits 500 and 506) and Z-type qubits are denoted by large, open circles (e.g., qubits 502 and 508). To entangle neighboring qubits, different gates are applied depending on the types of qubits being entangled. To entangle two X-type qubits, the usual CZ gate is applied, while to entangle an X- and a Z-type qubit, the CX gate 504 is applied, where the X-type qubit is the control qubit, and the Z-type qubit is the target qubit. Importantly, the entangling gates are still mutually commuting, and may be applied in any order. In this construction, both the CX and CZ gates must be bias-preserving. CX gates that preserve Z-bias have already been proposed in multiple qubit platforms, while CZ gates naturally preserve Z-bias since Z errors naturally commute with CZ.

This generalized construction allows for the building of two distinct one-dimensional teleportation cluster states, which are illustrated in FIGS. 5D-5G. The first, shown in FIGS. 5D and 5E, is the X-start cluster state, which begins with a state |ψ [symbol] on the first qubit 506, followed by alternating Z-type qubits 502 and X-type qubits 500. While the first qubit is not initialized in a |+ [symbol] state, it is treated as an X-type qubit during entanglement and measurement. The second one-dimensional teleportation cluster state, shown in FIGS. 5F and 5G, is the Z-start cluster state, which begins with a state |ψ [symbol] on the first qubit 506, followed by alternating X-type qubits 500 and Z-type qubits 502. Here, the first qubit 506 is treated as a Z-type qubit during entanglement and measurement.

After applying the entangling gates, the new logical operators and stabilizers are obtained from the old by conjugating with the entangling gates. This sends:

$${Z}_{i} \to {Z}_{i} \qquad {X}_{i} \to {X}_{i} {{\prod }_{j ∈ {𝒩}_{𝒾}}}_{j ∈ 𝒳} {Z}_{j} {{\prod }_{k ∈ {𝒩}_{𝒾}}}_{k ∈ 𝒵} {X}_{k} \qquad i ∈ 𝒳$$

$${X}_{i} \to {X}_{i} \qquad {Z}_{i} \to {Z}_{i} {{\prod }_{j ∈ {𝒩}_{𝒾}}}_{j ∈ 𝒳} {Z}_{j} \qquad i ∈ 𝒵$$

where [symbol] and [symbol] denote the set of X-type and Z-type qubits, respectively, and [symbol] ᵢ denotes the neighbors of site i. For X-start cluster states, there are logical operators X_{L}=X₁X₂ and Z_{L} Z₁ with stabilizers {Z₁Z₂Z₃, X₂X₃X₄, . . . }, while for Z-start cluster states there are logical operators X_{L}=X₁ and Z_{L}=Z₁Z₂ with stabilizers {X₁X₂X₃,Z₂Z₃Z₄, . . . }. By multiplying the logical operators by the stabilizers for each type of cluster state, the can be expressed in a form that involves only X operators on the first n X-type qubits and only Z operators on the first n Z-type qubits, as shown in FIGS. 5E and 5G. In the case of the X-start cluster state:

$${X}_{L} = ( {{\prod }_{i \leq 2 n}}_{i odd} {X}_{i} ) {X}_{2 n + 1} {X}_{2 n + 2}$$

$${Z}_{L} = ( {{\prod }_{i \leq 2 n}}_{i even} {Z}_{i} ) {Z}_{2 n + 1}$$

while in the case of the Z-start cluster state, there are

$${X}_{L} = ( {{\prod }_{i \leq 2 n}}_{i even} {X}_{i} ) {X}_{2 n + 1}$$

$${Z}_{L} = ( {{\prod }_{i \leq 2 n}}_{i odd} {Z}_{i} ) {Z}_{2 n + 1} {Z}_{2 n + 2}$$

The case of n=3 for both clusters is illustrated in FIGS. 5D-5G. This form makes it clear that if the first n X-type qubits are measured in the X basis and the first n Z-type qubits are measured in the Z-basis, the logical operators will be teleported to qubits {2n+1,2n+2}. For example, in the case n=3 for the X-start cluster state, if qubits 1-6 are measured with outcomes {x₁,z₂,x₃,z₄,x₅,z₆} with xᵢ,zᵢ=±1, the above equations imply that the logical operators are given by:

X_{L}=x₁x₃x₅x₇x₈

Z_{L}=z₂z₄z₆z₇.

Importantly, in this cluster state, Z_{L} is the product of physical Z operators and X_{L} is the product of physical X operators, meaning that physical Z errors cannot cause a logical X_{L} error. Thus, both teleportation clusters preserve the noise bias. These bias-preserving teleportation clusters can be used to foliate any biased-noise stabilizer code to gain a large threshold advantage which was not possible with the conventional approach.

To build a bias-preserving cluster state realizing the XZZX code, it is most convenient to use an alternating grid of X-start and Z-start cluster states, as shown in FIG. 5H. For each plaquette 114 of the XZZX code, an X-type ancilla qubit is added. These ancilla qubits are also initialized in the |+ [symbol] state and entangled with their neighbors. Measuring an ancilla qubit in the X basis results in measuring the XZZX code stabilizer of the corresponding plaquette during the teleportation. The resulting XZZX cluster state is shown in FIG. 5I, with unit cell 520.

The XZZX cluster state can be obtained from the RHG cluster state by applying Hadamard (H) gates at the site of Z-type qubits, just as the XZZX surface code can be obtained from the usual surface code by conjugating the stabilizers by H on alternating qubits. However, it is important to physically build the XZZX cluster state with CX and CZ gates rather than applying H gates to the RHG lattice, as an H operation does not preserve noise bias.

Each cell of the XZZX cluster state has four X-type qubits and two Z-type qubits on its faces; it is straightforward to show that for an XZZX cluster state without errors, the product of the X operators on the X-type qubits and the Z operators on the Z-type qubits is a stabilizer of the state, so the product of the corresponding X and Z measurements should be (+1). As shown in FIG. 5J, a Z or Y error on an X-type qubit 532 flips the syndromes of the neighboring cells, as does an X or Y error on a Z-type qubit 530. Note that X errors on the overall cluster state have no effect on X-type qubits and Z errors on the overall cluster state have no effect on Z-type qubits, although Z errors on Z-type qubits occurring between two CX gates will propagate to Z errors on neighboring X-type qubits, and similar for X errors on X-type qubits. Using a bias-preserving CX gate ensures that Z errors do not propagate to X or Y errors. Overall, errors can again be corrected by pairing (−1) syndromes to each other using a MWPM decoder. Importantly, we observe that in the XZZX cluster state Z errors create error chains that are restricted to disconnected 2D planes, while in the RHG cluster state Z errors create error chains that may meander in three dimensions. Intuitively, this makes decoding the XZZX cluster state easier in the presence of biased noise. This effective reduction in dimensionality of the matching graph in the case of biased noise is a mechanism for increased thresholds in the tailored and XZZX surface codes.

To demonstrate the advantage of the XZZX cluster state in the presence of biased noise, full circuit-level noise simulations were performed for both the XZZX cluster state and the RHG cluster state. The simulations use a physically well motivated biased noise model. In this model, CZ_{c,t} gates experience errors [symbol] _{c}Zₜ and Z_{c} [symbol] ₜ with probability p_{z}, Z_{c}Zₜ with probability p_{z}², and all other errors with probability p_{z}η. In addition, CX_{c,t} gates experience errors [symbol] _{c}Zₜ and Z_{c}Zₜ with probability p_{z}/2, Z_{c} [symbol] ₜ with probability p_{z}, and all other errors with probability p_{z}η. Finally, during both preparation and measurement, each qubit experiences Z errors with probability p_{z} and X and Y errors with probability p_{z}η.

In addition, the RHG cluster state is simulated under X-biased noise, to verify the earlier argument that the RHG cluster state should not have a notably higher threshold under X-biased noise. For X-biased noise in the RHG cluster state, a physically-motivated error model based on a specific implementation of CZ gates is used. Note that even when it is assumed that X-biased noise is on the physical qubits, the noise of the CZ gates is not expected to be X-biased as CZ gates do not preserve X-bias. In this model, after applying a CZ_{c,t} gate, the errors I_{c}Xₜ, X_{c}Iₜ, Z_{c}Xₜ, and X_{c}Zₜ occur with probability 0.375pₓ, the errors I_{c}Yₜ, Y_{c}Iₜ, Z_{c}Yₜ and Y_{c}Zₜ occur with probability 0.125pₓ, and all other errors occur with probability pₓη. In addition to errors during the CZ gates, during both preparation and measurement X errors occur with probability pₓ and Y and Z errors occur with probability pₓη.

In the Z-biased noise model, the total error probability of CZ gates is 2p_{z}+p_{z}²+12p_{z}η and the total error probability of CX gates is 2p_{z}+12p_{z}η, where η is a parameter of the error model and does not represent the ratio of the probability of dephasing errors to the probability of errors which cause bit flips. This ratio, which is often quoted as the bias, is η/6, so that e.g. η=1000 corresponds to a ratio of probabilities equal to 166.67. In the X-biased noise model, the total error probability of CZ gates is 2pₓ+7pₓη. To compare the cluster states, the threshold is measured in terms of the error probability of CZ gates, although the CX gate in the XZZX cluster state has a near-identical error rate to the CZ gate for low p_{z}. For each noise model, a MWPM decoder for circuit level-noise is used to correct the errors.

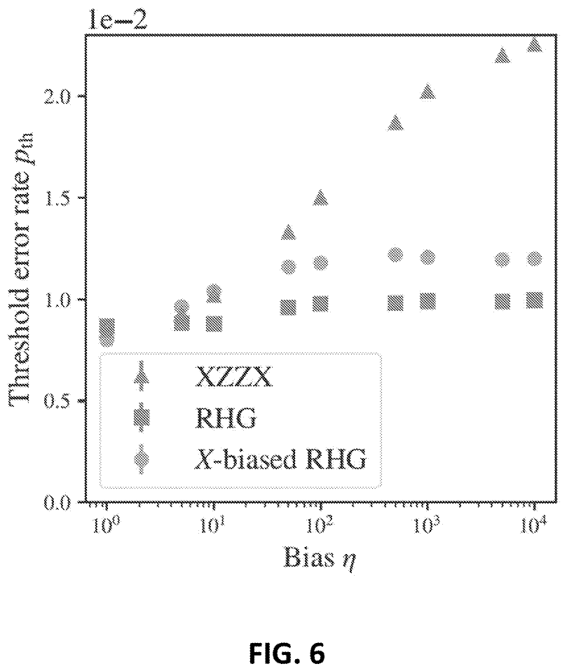

FIG. 6 is a graph showing the threshold error rate as a function of bias for XZZX and RHG cluster states, in accordance with some embodiments described herein. In FIG. 6, the results are plotted for the threshold of 1≤η≤10000. At η=1, the thresholds for all three cluster states are similar. As η is increased, the threshold of the RHG cluster state with X-biased noise outperforms the RHG cluster state with Z-biased noise; however, the error threshold of our XZZX cluster state strongly outperforms both versions of the RHG cluster state. For high bias, η≥1000, the threshold of the XZZX cluster state has pₜₕ>2.2%, more than double the threshold of the RHG cluster state with Z-biased noise which has pₜₕ<1.0%.

### IV. Building the XZZX Cluster State Using Fusion

In the most common measurement-based error correction (MBEC) framework, the cluster state is generated using a set of commuting two-qubit entangling gates. Alternatively, one could start with several copies of smaller few-body entangled states and then stitch them together into a many-body entangled cluster state using destructive measurements of two-qubit Pauli operators: X⊗X and Z⊗Z, also called fusions or Bell measurements. This approach has been referred to as fusion-based error correction (FBEC) and is a more natural choice for architectures where fusions are the primitive operations like discrete variable photonic qubits, superconducting continuous variable qubits, and Majorana qubits.

The inventors have accordingly developed fusion-based architectures for error correction with the XZZX cluster state. The inventors have developed two constructions, one based on using a collection of four-qubit entangled resource states and the other based on using a collection of six-qubit entangled resource states. Importantly, both the constructions offer practical advantage when noise in the fusion circuit is biased so that X⊗X measurements are more unreliable than Z⊗Z measurements. This is because errors introduced in the cluster states due to faulty X⊗X measurements give rise to a two-dimensional system symmetry which considerably simplifies the decoding problem, leading to substantial improvement in threshold to biased fusion-noise.

The fusion-based techniques described herein are motivated by dual-rail qubits in linear optics, which is the most widely studied platform in the framework of FBEC. Linear-optic fusions on dual rail qubits are inherently probabilistic. The simplest fusion circuit fails with probability ½. The failure probability can be reduced to ½′ using ancilliary (2ⁿ-2)-photon entangled states, although for the special case of n=2, 4 unentangled photons are sufficient to achieve ¼ failure probability. Notably, when a fusion attempt fails, the X⊗X information is completely erased but the Z⊗Z information can still be recovered. The architecture described herein leverages this biased noise structure to achieve record-high thresholds to fusion failures. With numerical simulations of the fusion-based XZZX cluster state with photonic dual-rail qubits and entangled ancillas, a threshold to fusion failures exceeding 25% is achieved in the experimentally relevant regime of non-zero loss rate per photon. This is the highest known threshold to fusion failures in linear optics without additional encodings on the photonic state, and for the first time allows scalable FBEC using an ancilla of only two entangled photons or four unentangled photons.

Given the significant increase in the error threshold of the XZZX cluster state under biased noise, the next step is to consider what qubit platforms might naturally take advantage of the increased threshold. However, in this section we make some preliminary suggestions for quantum computing approaches that may benefit from realizing the XZZX cluster state rather than another form of error correction. Each of the following proposals uses a two-step strategy to realize the XZZX cluster state, in which small cluster states are first generated (“initial resource states”), and then the XZZX cluster state is generated by fusing X-type qubits with Z-type qubits using Bell measurements. Such fusions are bias-preserving: Z errors on qubits involved in the fusion result in Z errors on the final cluster state. Furthermore, as demonstrated for specific platforms below, the additional errors introduced during the fusions are also Z-biased. Thus, these constructions all result in a final cluster state with Z-biased noise.

A prime candidate for realizing the XZZX cluster state is dual-rail encoded photonic qubits, in which a qubit is represented by a photon being in one of two photonic modes. Denoting the qubit state by |0̅ [symbol] and |1̅ [symbol] , the qubit state can be defined as |0̅ [symbol] :=|10 [symbol] and |1̅ [symbol] :=|01 [symbol] . Using only standard linear-optical elements, one can apply arbitrary single-qubit gates to dual-rail qubits, but entangling operations are inherently probabilistic. Modern architecture proposals for dual-rail photonic qubits involve building a cluster state from smaller resource states using probabilistic destructive Bell measurements (“fusions”). To correct errors, these protocols use the RHG cluster state, but by using modified resource states one can instead realize the XZZX cluster states. Building the XZZX cluster state from the resource states uses the same number of fusion measurements as the RHG cluster state.

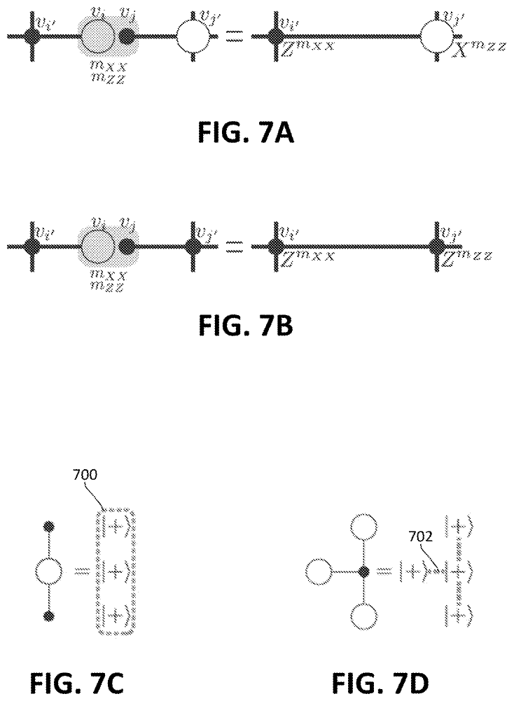

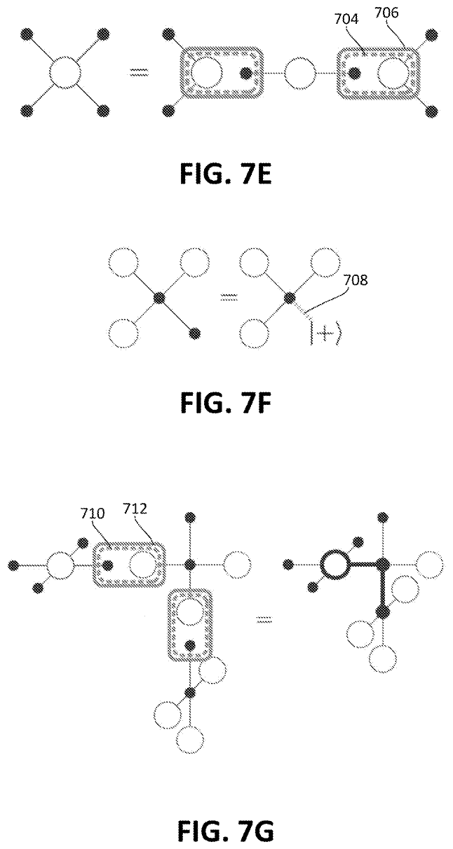

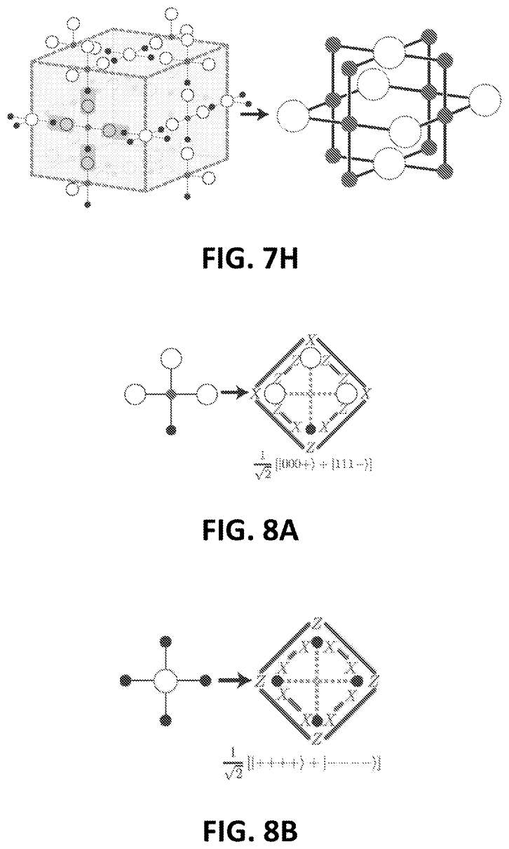

FIGS. 7A-7J illustrate one method to build the XZZX cluster state with fusions. FIGS. 7A and 7B show two fusion processes for dangling X-type and Z-type qubits. Consider a cluster state defined on a graph G=(V,E). Let G have a Z-type qubit at a degree-1 vertex vᵢ with an edge to a qubit at v_{i′}, and an X-type qubit at degree-1 vertex vⱼ with an edge to a qubit at v_{j′}≠v_{i′}. The qubit on a degree-1 vertex is referred to as a “dangling qubit” herein. As shown in FIGS. 7A and 7B, performing Xᵢ⊗Xⱼ and Zᵢ ⊗Zⱼ measurements on the pair of dangling qubits disentangles them from the rest of the system, removing vertices vᵢ, vⱼ and edges (vᵢ, v_{i′}), (vⱼ, v_{j′}) and adding a new edge (v_{i′}, v_{j′}). Consequently, the stabilizers centered at vᵢ and vⱼ are removed and two new stabilizers are obtained centered at v_{i′} and v_{j′}. To ensure that the new cluster state is the +1 eigenstate of these new stabilizers, a Pauli correction is applied to the qubits at v_{i′} and v_{j′} according to the outcomes of the Xᵢ⊗Xⱼ measurement (m_{XX}) and the Zᵢ⊗Zⱼ measurement (m_{ZZ}). If v_{i′}∈ [symbol] and v_{j′}∈ [symbol] , the correction is Z_{i′}^{m}^{_{XX}}⊗Z_{j′}^{m}^{_{ZZ}}, while if v_{i′}, v_{j′}∈ [symbol] , the correction is Z_{i′}^{m}^{_{XX}}⊗Z_{j′}^{m}^{_{ZZ}}. It is not necessary to physically apply these Pauli corrections and instead they may just be tracked in software. Observe that in case of unreliable Xᵢ⊗Xⱼ(Zᵢ⊗Zⱼ) measurements, the proper Pauli correction on v_{i′} (v_{j′}) cannot be properly corrected, which results in an effective error on that qubit. In fact, a complete erasure of the X⊗X measurement outcome that arises due to fusion-failure in linear-optics is equivalent to applying I or Z to the X-type qubit at v_{i′} with 50% probability.

FIGS. 7C and 7D are schematic diagrams of illustrative three- and four-qubit cluster states, in accordance with some embodiments described herein. The three-qubit cluster state of FIG. 7C may be generated by initializing two X-type qubits and one Z-type qubit in the |+ [symbol] state and performing a three-qubit Z measurement 700 to couple the three qubits. The four-qubit cluster state of FIG. 7D may be generated by initializing three Z-type qubits and one X-type qubit in the |+ [symbol] state and performing two-qubit Z measurements 702 to couple the qubits as shown.

FIGS. 7E and 7F illustrate the generation of a larger five-qubit cluster state by fusing the elementary cluster states of FIGS. 7C and 7D, in accordance with some embodiments described herein. The five-qubit cluster state of FIG. 7E may be generated using non-destructive Z⊗Z measurements 704 followed by destructive X⊗X measurements 706. The five-qubit cluster state of FIG. 7F may be generated by initializing an additional X-type qubit in the |+ [symbol] state and performing a CZ gate 708 between the newly-initialized qubit and the central qubit of the four-qubit cluster state of FIG. 7D.

The five-qubit cluster state of FIG. 7E has a Z-type qubit at the center and the five-qubit cluster state of FIG. 7F has an X-type qubit at its center. The center qubits will eventually be used to form the desired XZZX cluster state. The Z-centered and X-centered states are placed at the location of Z- and X-type qubit respectively in the desired cluster state, as shown in FIG. 7H. This arrangement of the 5-body states ensures that neighboring dangling qubits are always opposite types; and the neighboring dangling qubits can be fused according to FIGS. 7A and 7B. These initial resource states comprising five-qubit cluster states may then be fused to generate the larger XZZX cluster state, in some embodiments. FIG. 7G illustrates the generation of a portion of the XZZX cluster state using the five-qubit cluster states of FIGS. 7E and 7F. To fuse these five-qubit cluster states, non-destructive Z⊗Z measurements 710 followed by destructive X⊗X measurements 712 between qubits of two five-qubit cluster states are performed.

The fused qubits are removed from the cluster and new bonds appear between the central qubits, resulting in the desired XZZX cluster state. Finally, the cluster state qubits can be measured in the appropriate basis described in the previous section for error correction. Note that each center qubit is entangled into the final cluster state after four fusion measurements on its neighboring dangling qubits; consequently, four Pauli corrections are to be accounted for on this qubit. This accounting may be done in software by simply re-interpreting the outcome of the final measurement of cluster state qubits. This is because an X (Z) measurement of the X- (Z-) type qubit in the cluster state after a Pauli Z (X) is applied to it is equivalent to a X (Z) measurement followed by a classical flip of the measurement outcome ±1→∓1.

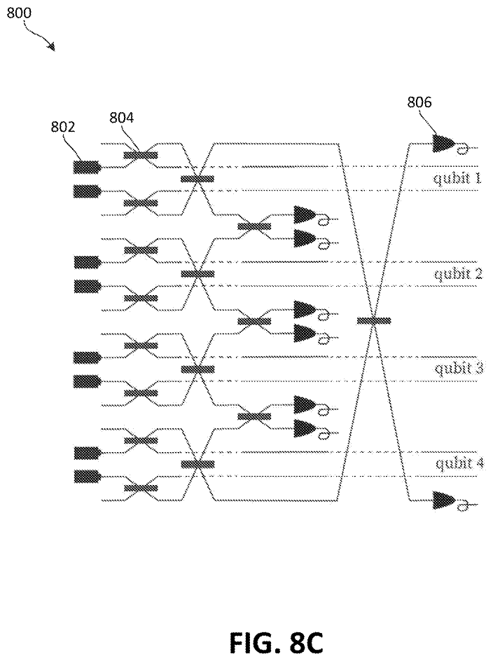

It is possible to simplify the initial 5-qubit cluster states to 4-qubit cluster states by noting that measuring the qubits comprising the final cluster state commute with fusion measurements, as these measurements are performed on different qubits and Pauli corrections due to fusions can simply be accounted for in software. That is, the center qubits which would form the XZZX cluster state can be measured before performing the fusion measurements. Once the fusions are realized, the outcomes of the prior center-qubit measurements can be flipped conditional on the fusion outcomes. Measuring the center X- and Z-type qubits of the 5-qubit states in the X and Z basis respectively generates the simpler 4-star resource states shown in FIGS. 8A and 8B. Thus, the process of generating the XZZX cluster state can directly start with these four-qubit resource states assuming that the center qubits have been measured in the X/Z basis with +1 measurement outcome. In this approach, the central qubit acts like a virtual qubit. It is never physically realized and never physically measured, and its effective measurement outcome is entirely determined by the Pauli corrections that are tracked in software.

FIG. 8C is a schematic diagram of an illustrative photonic circuit 800 to generate the four-qubit cluster states of FIG. 8A, in accordance with some embodiments described herein. The photonic circuit 800 includes a number of single photon sources 802, 50:50 beamsplitters 804, and photodetectors 806. The four-qubit cluster states can be probabilistically generated from single photons by a sequence of beam splitters and photon detectors, conditioned on a certain detector output. The photonic circuit 800 succeeds if a single photon is output at each detector pair. The photonic circuit 800 may be altered to generate the four-qubit cluster state of FIG. 8B by further including beamsplitters applied to three of the four qubits output from photonic circuit 800.

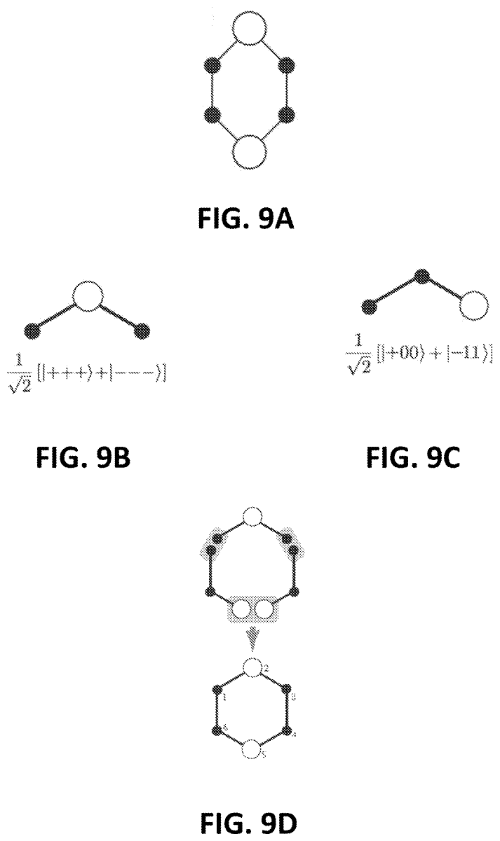

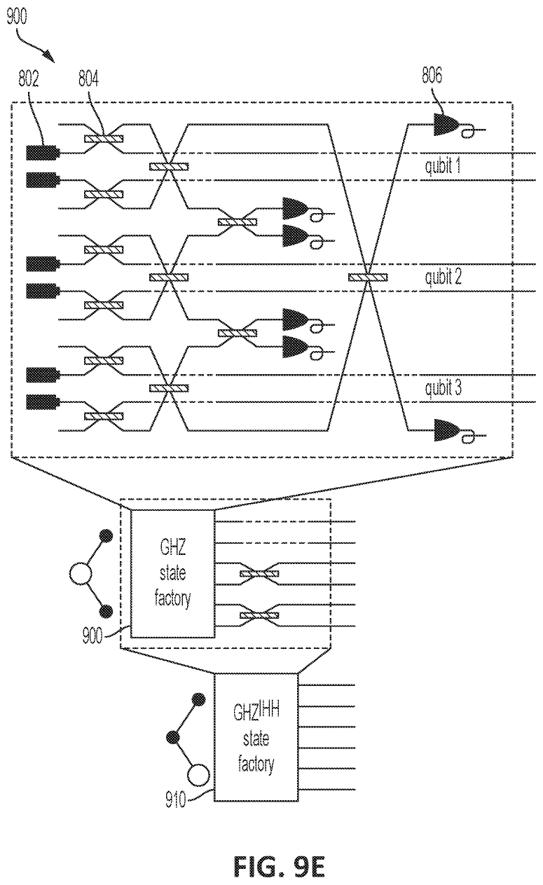

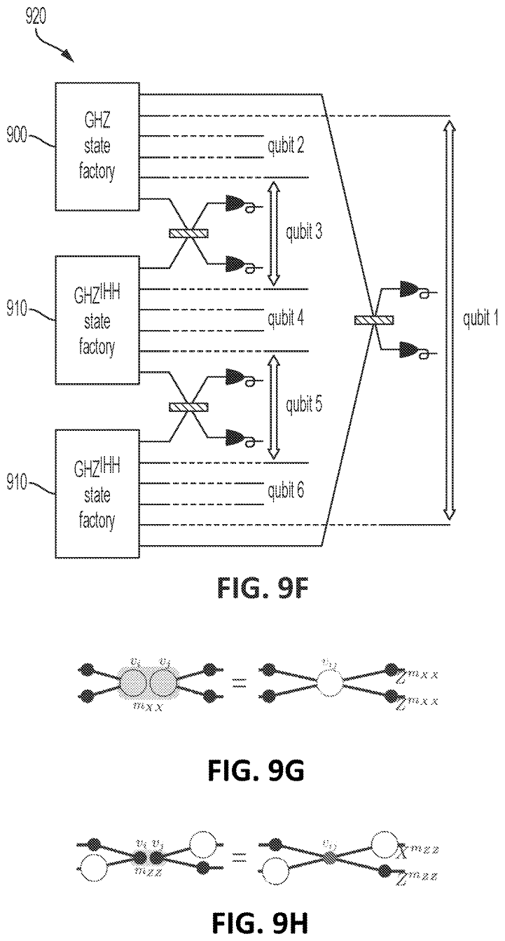

As an alternative, the XZZX cluster state may be generated using six-qubit resource states, an example of which is depicted in FIG. 9A. The six-qubit resource states may be generated based on three-qubit GHZ states illustrated in FIGS. 9B and 9C. The six-ring resource state may then be constructed by performing fusions on a set of three GHZ states, as depicted in FIG. 6D.

In some embodiments, the three-qubit GHZ states may be generated using the circuits of FIG. 6E. The base GHZ state (|+++ [symbol] +|−−− [symbol] )/√2 (up to heralded Pauli corrections) may be generated by the photonic circuit 900 shown in FIG. 9E when one photon is detected at each pair of detectors. This occurs with probability 1/32. The second GHZ state of FIG. 9C may be generated by a photonic circuit 910 including the photonic circuit 900 and two additional beam splitters performing Hadamard operations. These input states may be fed into the circuit 920 of FIG. 9F, which performs fusions between the peripheral qubits of the individual GHZ states to generate the six-qubit cluster state as depicted in FIG. 9D.

To generate the XZZX cluster state using these six-qubit resource states, qubits having a same type (e.g., X or Z) of the six-qubit resource states may be fused, in some embodiments and as illustrated in FIGS. 9G and 9H. Consider a cluster state defined on a graph G=(V,E) with Z- (X)-type qubits at vertices vᵢ, vⱼ∈V such that (vᵢ,vⱼ)∉E and vᵢ and vⱼ share no neighbors in common. Measuring Xᵢ⊗Xⱼ(Zᵢ⊗Zⱼ) on these two qubits projects them into an effective two-dimensional subspace with the Pauli operators X̅=Xᵢ(Xᵢ⊗Xⱼ) and Z̅=Zᵢ⊗Zⱼ(Zᵢ). As shown in FIGS. 9G and 9H, a new cluster state is obtained with vertices vᵢ, vⱼ replaced by a single vertex vii and an effective Z- (X)-type qubit placed at this vertex. All the edges incident at vᵢ and vⱼ are incident at vᵢⱼ in the new graph. To ensure that the new cluster state is the +1 eigenstate of all the stabilizers, a Pauli correction determined by the Xᵢ⊗Xⱼ(Zᵢ⊗Zⱼ) measurement outcome, m_{XX} (m_{ZZ}), must be applied to the qubits that were originally adjacent to vⱼ. Specifically Z^{m}^{_{XX}} (Z^{m}^{_{ZZ}}) is applied to adjacent X-type qubits and X^{m}^{_{XX}} (X^{m}^{_{ZZ}}) is applied to adjacent Z-type qubits.

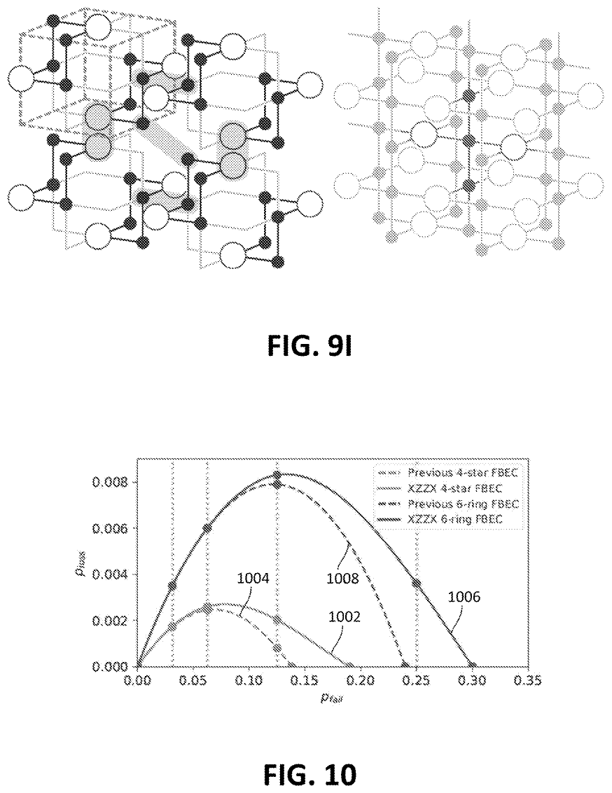

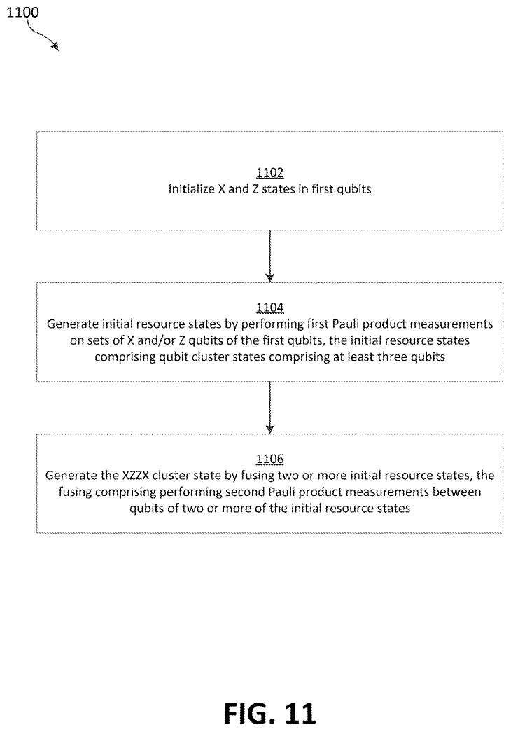

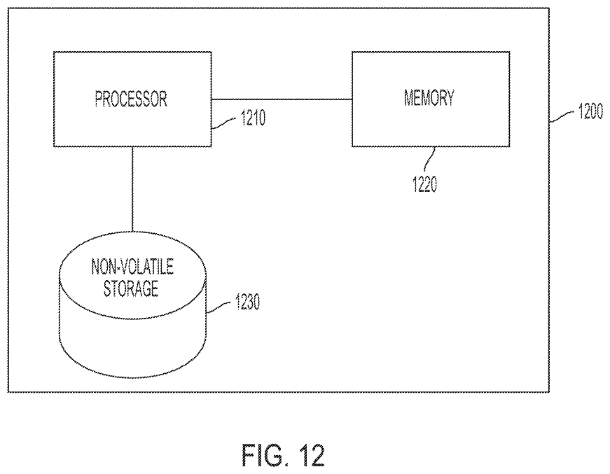

To generate the XZZX cluster state using the 6-ring resource cluster state of FIG. 9A, two copies of the six-qubit cluster state may be placed at opposite corners of each unit cell of the XZZX cluster state as shown in FIG. 91. Two qubits of the same type share a face or an edge. If Z⊗Z of each pair of Z-type qubits is measured and X⊗X of each pair of X-type qubits is measured sharing a face and/or edge, and apply the required Pauli-corrections, the desired XZZX cluster state is generated and comprised of the effective qubits. Note that an unreliable X⊗X measurement on Z-type qubits only leads to an incorrect Pauli Z correction to its adjacent X-type qubits. Finally, the effective Pauli X̅=X⊗X is measured of the effective X-type qubits and effective Pauli Z̅=Z⊗Z of the effective Z-type qubits is measured for error correction. Note that an unreliable X⊗X measurement in the second set of measurements is like a Z̅ error on the effective X-type qubits. As before, physical application of Pauli corrections from the first set of measurements that create the cluster state is not necessary. These may be simply tracked in software by re-interpreting the outcomes of the second set of measurements that are used for error correction. Overall then, error correction is implemented in our construction by measuring commuting observables X⊗X and Z⊗Z, that is performing fusions, on pairs of qubits that share an edge or a face The above discussion implies that a biased-fusion failure, as is the case in linear optics, effectively leads to biased-Pauli Z noise on the X-type qubits of the XZZX cluster state.

So far imperfections in practical hardware which can introduce photon loss have been ignored. Fortunately, the ideal fusion circuit preserves the number of photons, that is, the total detector clicks must be equal to the number of input photons. So a loss of any photon in the fusion circuit will be heralded by observing fewer than expected clicks at the detector and result in an erasure of both X⊗X and Z⊗Z measurement outcomes. If the probability of loss per photon is pₗₒₛₛ, then the probability of such an erasure in the boosted fusion circuit with a total of 1/p_{fail} photons is p_{fail erase}=1−(1−pₗₒₛₛ)^{1/p}^{_{fail}}. This equation highlights the tradeoff between the rate at which only the X⊗X outcome is erased due to fusion-failure and the rate at which both X⊗X and Z⊗Z outcomes are erased due to photon loss. It is desirable to decrease p_{fail} by adding more photons in the fusion circuit; however, that comes at the cost of decreased probability of no photon loss from the fusion circuit and thus increase in P_{fail erase}.

FIG. 10 is a threshold curve for XZZX cluster states generated using four-qubit and six-qubit resource states, in accordance with some embodiments described herein. Curves 1002 and 1006 represent the threshold curve as simulated for the techniques to construct the XZZX cluster state described herein. In contrast, curves 1004 and 1008 represent the threshold curve as simulated for prior techniques to construct the XZZX cluster state. Both curves 1002 and 1006 indicate higher error thresholds than curves 1004 and 1008. Additionally, the thresholds for the six-ring construction are higher than the four-star construction as it has fewer fusions, and hence lower probability of error, per cluster state qubit. In the absence of photon loss, the numerically obtained threshold for biased fusion-failure using our scheme is ˜30.5% for the six-ring construction and ˜19% for the four-star construction. These numerically obtained thresholds are significantly higher than the threshold for unbiased fusion-failure obtained with previous proposals, which are correspondingly ˜24% for the six-ring construction and ˜14.5% for the four-star construction. This is because, as described earlier, pure fusion failure leads to two-dimensional system symmetry and hence a two-dimensional syndrome graph which is easier to decode. In contrast, with previous strategies the syndrome graph that results from pure fusion failures is three-dimensional, which is harder to decode.

By taking advantage of the biased structure of fusion failures, the inventors have introduced new resource states and fusion strategies for FBEC that allow for more efficient error correction of biased fusion failures. This FBEC strategy is particularly relevant to linear-optical quantum computers based on dual-rail photonic qubits, where biased fusion failures are the dominant source of error. The resource states and fusion strategies described herein require no additional overhead to realize but result in higher thresholds to fusion failures for both the 4-star and 6-ring resource states. In the 6-ring construction in particular, the described techniques have a threshold over 25% to fusion failures, which can be reached using only a 2-photon entangled ancilla or a 4-photon unentangled ancilla; thus, the described construction overcomes a key barrier for photonic quantum computing.

FIG. 11 is a flowchart describing a process 1100 of generating the XZZX cluster state using fusion measurements, in accordance with some embodiments described herein. In some embodiments, process 1100 may begin with act 1102, in which quantum states are initialized in first qubits. The first qubits may comprise X-type and Z-type qubits.

In some embodiments, the first qubits may comprise photonic qubits. In such embodiments, initializing the states in the first qubits may comprise generating the photonic qubits using one or more light sources. For example, the photonic qubits may be generated by one or more single photon sources.

In some embodiments, the first qubits may comprise trapped neutral atoms. In such embodiments, initializing the states in the first qubits may comprise exciting a state of the trapped neutral atoms by driving the trapped neutral atoms with a driving signal. The driving signal may be, for example, an optical and/or microwave signal. Initializing the states in the first qubits may therefore comprise generating one or more optical or microwave signals using one or more optical or microwave sources; and transmitting the generated one or more optical or microwave signals to the first qubits to initialize the states.

In some embodiments, after act 1102, the process 1100 may proceed to act 1104, in which initial resource states (e.g., initial cluster states) are generated by performing first Pauli product measurements on sets of X and/or Z qubits of the first qubits. The initial resource states may comprise qubit cluster states comprising at least three qubits.

In some embodiments, generating the initial resource states comprises generating a first three-qubit cluster state. The first three-qubit cluster state may be generated by first initializing states in two X-type qubits and one Z-type qubit. Then, a three-qubit Z measurement may be performed on the initialized qubit to generate the first three-qubit cluster state by coupling the three qubits.

In some embodiments, generating the initial resource states comprises generating a five-qubit cluster state using one or more of the first three-qubit cluster states. Generating the five-qubit cluster state may comprise fusing each of the two X-type qubits of the first three-qubit cluster state with a Z-type qubit of second and third three-qubit cluster states. Fusing the two X-type qubits with Z-type qubits may comprise making a fusion measurement (e.g., performing two-qubit Z measurements and two-qubit X measurements, performing a Bell measurement) between one of the X-type qubits and a respective Z-type qubit.

In some embodiments, generating the initial resource states comprises generating a four-qubit cluster state. The four-qubit cluster state may be generated by first initializing states in three Z-type qubits and one X-type qubit. Thereafter, the four-qubit cluster state may be generated by performing two-qubit Z measurements between each of the three Z-type qubits and the one X-type qubit. In some embodiments, a five-qubit cluster state may further be generated using the four-qubit cluster state. The five-qubit cluster state may be generated by first initializing a state in an additional X-type qubit and thereafter performing a CZ gate between the additional X-type qubit and the one X-type qubit of the four-qubit cluster state.

In some embodiments, generating the initial resource states comprises separately generating a four-qubit cluster state. This four-qubit cluster state may be generated by first initializing states in four X-type qubits. Thereafter, the four-qubit cluster state may be generated by performing two-qubit X measurements between pairs of qubits of the initialized four X-type qubits. In some embodiments, the four-qubit cluster state may further be generated by performing a Z measurement of three of the initialized four X-type qubits.

In some embodiments, generating the initial resource states comprises generating a six-qubit cluster state (e.g., a six-ring cluster state). The six-qubit cluster state may be generated by first generating three three-qubit cluster states. The three-qubit cluster states may be generated by initializing states in six X-type qubits and three Z-type qubits, and for each of the three three-qubit cluster states, performing at least four two-qubit X and/or Z measurements to generate the three three-qubit cluster states. Thereafter, qubits of the three-qubit cluster states may be fused to generate the six-qubit cluster state. The six-qubit cluster state may comprise two Z-type qubits and four X-type qubits.

In some embodiments, after act 1104, the process 1100 may proceed to act 1106, in which the XZZX cluster state is generated by fusing two or more initial resource states, the fusing comprising performing second Pauli product measurements between qubits of two or more of the initial resource states. In some embodiments, fusing two or more initial resource states comprises performing a Bell measurement between a first qubit of a first initial resource state and a second qubit of a second initial resource state.

An illustrative implementation of a classical computer system 1200 that may be used in connection with any of the embodiments of the disclosure provided herein is shown in FIG. 12. In some embodiments, any one of the processes described herein may be implemented on and/or using the computer system 1200. The computer system 1200 may include one or more processors 1210 and one or more articles of manufacture that comprise non-transitory computer-readable storage media (e.g., memory 1220 and one or more non-volatile storage media 1230). The processor 1210 may control writing data to and reading data from the memory 1220 and the non-volatile storage device 1230 in any suitable manner. To perform any of the functionality described herein, the processor 1210 may execute one or more processor-executable instructions stored in one or more non-transitory computer-readable storage media (e.g., the memory 1220), which may serve as non-transitory computer-readable storage media storing processor-executable instructions for execution by the processor 1210.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be tangible (e.g., non-transitory) computer readable media. In some embodiments, the computer readable media may comprise a persistent memory.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone, or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods.

The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A quantum system, comprising:
at least one controller; and
at least one non-transitory computer readable medium storing computer readable instructions configured to cause the at least one controller to generate an XZZX cluster state, the generating comprising:
initializing states in first qubits, the first qubits comprising X-type and Z-type qubits;
generating initial resource states by performing first Pauli product measurements on sets of X-type and/or Z-type qubits of the first qubits, the initial resource states comprising qubit cluster states comprising at least three qubits; and
generating the XZZX cluster state by fusing two or more initial resource states, the fusing comprising performing second Pauli product measurements between qubits of two or more of the initial resource states.

2. The quantum system of claim 1, further comprising single photon sources, wherein initializing the states in the first qubits comprises generating photonic qubits using the single photon sources.

3. The quantum system of claim 1 or 2, wherein generating the initial resource states comprises generating a first three-qubit cluster state by:
initializing states in two X-type qubits and one Z-type qubit; and
generating the first three-qubit cluster state by performing a three-qubit Z measurement on the initialized qubits.

4. The quantum system of claim 3, wherein generating the initial resource states comprises generating a five-qubit cluster state by fusing each of the two X-type qubits of the first three-qubit cluster state with a Z-type qubit of second and third three-qubit cluster states.

5. The quantum system of claim 4, wherein fusing each of the two X-type qubits of the first three-qubit cluster state with a Z-type qubit of second and third three-qubit cluster states comprises:
performing two-qubit Z measurements between each of the two X-type qubits and the Z-type qubits; and
performing two-qubit X measurements between each of the two X-type qubits and the Z-type qubits.

6. The quantum system of any one of claims 1 to 5, wherein generating the initial resource states comprises generating a four-qubit cluster state by:
initializing states in three Z-type qubits and one X-type qubit; and
generating the four-qubit cluster state by performing two-qubit Z measurements between each of the three Z-type qubits and the one X-type qubit.

7. The quantum system of claim 6, wherein generating the initial resource states comprises generating a five-qubit cluster state by:
initializing a state in an additional X-type qubit; and
performing a CZ gate between the additional X-type qubit and the one X-type qubit of the four-qubit cluster state.

8. The quantum system of any one of claims 1 to 7, wherein generating the initial resource states comprises generating a four-qubit cluster state by:
initializing states in four X-type qubits; and
generating the four-qubit cluster state by performing two-qubit X measurements between pairs of qubits of the initialized four X-type qubits.

9. The quantum system of claim 8, wherein generating the four-qubit cluster state further comprises performing a Z measurement of three of the initialized four X-type qubits.

10. The quantum system of any one of claims 1 to 9, wherein generating the initial resource states comprises generating a six-qubit cluster state by:
generating three three-qubit cluster states; and
fusing qubits of the three three-qubit cluster states to generate a six-qubit cluster state comprising two Z-type qubits and four X-type qubits.

11. The quantum system of claim 10, wherein generating the three three-qubit cluster states comprises:
initializing states in six X-type qubits and three Z-type qubits; and
for each of the three three-qubit cluster states, performing at least four two-qubit X and/or Z measurements to generate the three three-qubit cluster states.

12. The quantum system of any one of claims 1 to 11, wherein fusing two or more initial resource states comprises performing a Bell measurement between a first qubit of a first initial resource state and a second qubit of a second initial resource state.

13. The quantum system of any one of claims 1 or 3 to 12, further comprising:
a plurality of physical qubits comprising neutral trapped atoms; and
one or more optical or microwave sources coupled to the plurality of physical qubits.

14. A method of generating an XZZX cluster state for use in quantum information processing, the generating comprising:
initializing states in first qubits, the first qubits comprising X-type and Z-type qubits;
generating initial resource states by performing first Pauli product measurements on sets of X and/or Z qubits of the first qubits, the initial resource states comprising qubit cluster states comprising at least three qubits; and
generating the XZZX cluster state by fusing two or more initial resource states, the fusing comprising performing second Pauli product measurements between qubits of two or more of the initial resource states.

15. The method of claim 14, wherein initializing the states in the first qubits comprises generating photonic qubits using single photon sources.

16. The method of claims 14 or 15, wherein generating the initial resource states comprises generating a first three-qubit cluster state by:
initializing states in two X-type qubits and one Z-type qubit; and
generating the first three-qubit cluster state by performing a three-qubit Z measurement on the initialized qubits.

17. The method of any one of claims 14 to 16, wherein generating the initial resource states comprises generating a five-qubit cluster state by fusing each of the two X-type qubits of the first three-qubit cluster state with a Z-type qubit of second and third three-qubit cluster states.

18. The method of claim 17, wherein fusing each of the two X-type qubits of the first three-qubit cluster state with a Z-type qubit of second and third three-qubit cluster states comprises:
performing two-qubit Z measurements between each of the two X-type qubits and the Z-type qubits; and
performing two-qubit X measurements between each of the two X-type qubits and the Z-type qubits.

19. The method of any one of claims 14 to 18, wherein generating the initial resource states comprises generating a four-qubit cluster state by:
initializing states in three Z-type qubits and one X-type qubit; and
generating the four-qubit cluster state by performing two-qubit Z measurements between each of the three Z-type qubits and the one X-type qubit.

20. The method of claim 19, wherein generating the initial resource states comprises generating a five-qubit cluster state by:
initializing a state in an additional X-type qubit; and
performing a CZ gate between the additional X-type qubit and the one X-type qubit of the four-qubit cluster state.

21. The method of any one of claims 14 to 20, wherein generating the initial resource states comprises generating a four-qubit cluster state by:
initializing states in four X-type qubits; and
generating the four-qubit cluster state by performing two-qubit X measurements between pairs of qubits of the initialized four X-type qubits.

22. The method of claim 21, wherein generating the four-qubit cluster state further comprises performing a Z measurement of three of the initialized four X-type qubits.

23. The method of any one of claims 14 to 22, wherein generating the initial resource states comprises generating a six-qubit cluster state by:
generating three three-qubit cluster states; and
fusing qubits of the three three-qubit cluster states to generate a six-qubit cluster state comprising two Z-type qubits and four X-type qubits.

24. The method of claim 23, wherein generating the three three-qubit cluster states comprises:
initializing states in six X-type qubits and three Z-type qubits; and
for each of the three three-qubit cluster states, performing at least four two-qubit X and/or Z measurements to generate the three three-qubit cluster states.

25. The method of any one of claims 14 to 24, wherein fusing two or more initial resource states comprises performing a Bell measurement between a first qubit of a first initial resource state and a second qubit of a second initial resource state.

26. The method of any one of claims 14 or 16 to 25, wherein the first qubits comprise a plurality of neutral trapped atom qubits, and initializing states in the first qubits comprises:
generating one or more optical or microwave signals using one or more optical or microwave sources; and
transmitting the generated one or more optical or microwave signals to the first qubits to initialize the states.

27. A method of building a fault-tolerant cluster state using a quantum system that includes a plurality of physical qubits, the method comprising:
initializing an alternating grid of X-start and Z-start cluster states in physical qubits of the plurality of physical qubits;
initializing at least one physical qubit of the plurality of physical qubits to be an X-type qubit; and
measuring at least one physical qubit of the plurality of physical qubits in an X-basis to measure XZZX stabilizers of corresponding cluster states.

28. The method of claim 27, wherein initializing an alternating grid of X-start and Z-start cluster states comprises applying one or more CX and/or CZ gates to one or more of the plurality of physical qubits.

29. The method of claim 27 or 28, further comprising:
teleporting logical information to other physical qubits of the plurality of physical qubits by:
measuring X-type physical qubits in the X basis; and
measuring Z-type physical qubits in a Z basis.

30. The method of any one of claims 27 to 29, further comprising:
detecting an error in one of the plurality of physical qubits by measuring one of a Z error on an X-type physical qubit or an X error on a Z-type physical qubit.

31. The method of claim 30, wherein detecting an error comprises:
detecting a flipped stabilizer by measuring at least one X-type qubit.

32. A quantum system, comprising:
a plurality of physical qubits;
at least one computer readable medium storing a plurality of drive waveforms; and
at least one controller configured to:
initialize an alternating grid of X-start and Z-start cluster states in physical qubits of the plurality of physical qubits;
initialize at least one physical qubit of the plurality of physical qubits to be an X-type qubit; and
measure at least one physical qubit of the plurality of physical qubits in an X-basis to measure XZZX stabilizers of corresponding cluster states.
